(19) United States
(12) Patent Application Publication
(10) Pub. No.: US 2021/0383103 A1
(43) Pub. Date: Dec. 9, 2021

(54) SYSTEM AND METHOD FOR ASSESSING CUSTOMER SATISFACTION FROM A PHYSICAL GESTURE OF A CUSTOMER

(71) Applicant: ARCTAN ANALYTICS PTE. LTD., Singapore (SG)

(72) Inventor: Pierre André Octave HAUSHEER, Singapore (SG)

(73) Assignee: ARCTAN ANALYTICS PTE. LTD., Singapore (SG)

(21) Appl. No.: 17/264,363

(22) PCT Filed: Sep. 19, 2019
(86) PCT No.: PCT/SG2019/050470

§ 371 Date: Jan. 29, 2021

(51) Int. Cl. G06K 9/00; G06K 9/46; G06Q 30/02; G06N 3/08

(52) U.S. Cl. CPC G06K 9/00355; G06N 3/08; G06Q 30/0203; G06K 9/46

(57) ABSTRACT

A system and method for assessing customer satisfaction from a physical gesture of a customer, the system comprising:
a video camera (5) for capturing video frames of the customer (1) making the physical gesture; and
a deep-learning object-detection module for detecting the physical gesture by analysing the captured video frames, and for categorising the physical gesture as a specific customer feedback result.

### FIELD

The present invention is generally directed to deep neural networks for object detection, and in particular to a system and method for assessing customer satisfaction from a physical gesture of a customer.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Customer satisfaction is a cornerstone of any B2C business. However, assessing customer satisfaction is often not only inaccurate but also troublemaking. In particular, the process of assessing customer satisfaction is also part of the customer journey and as such it influences the very satisfaction this journey proclaims it generates.

Current solutions are based on phoning, paper survey, emails and touch screen devices. These solutions range from not satisfactory enough (such as self-service touch screen devices), which leads to customer not using them, to dissatisfactory (such as phoning), which leads to customer dissatisfaction.

Self-service touch screen devices can be located in retail or other premises to allow a customer to input their customer satisfaction rating immediately after the provision of a service. Such touch screen devices are for example provided outside public washrooms in the airport or shopping malls in Singapore for this purpose. However, they can also be seen to be non-hygienic because they will likely be touched by many people. Customers may therefore be disinclined to provide their feedback by using such a touch screen device for this reason.

An object of the invention is to ameliorate one or more of the above-mentioned difficulties.

### SUMMARY

According to one aspect of the disclosure, there is provided a system for assessing customer satisfaction from a physical gesture of a customer, comprising:

a video camera for capturing video frames of the customer making the physical gesture; and

a deep-learning object-detection module for detecting the physical gesture by analysing the captured video frames, and for categorising the physical gesture as a specific customer feedback result.

In some embodiments, the system may further comprise a display screen for displaying a visual image to the customer based on the customer feedback result.

In some embodiments, the system may further comprise a sound emitting device for emitting a sound to the customer based on the customer feedback result.

In some embodiments, the deep learning object detection module may include a processor located on site for running a machine learning algorithm based on a deep learning object detection model with a feature extractor. The deep learning object detection model may be a Single Shot MultiBox Detector (SSD) algorithm, while the feature extractor may be a Mobilenet algorithm.

In some embodiments, the deep learning module may further include a deep learning accelerator device for supporting the processing of a high video frame rate. The video frame rate may preferably be greater than or equal to 5 frames per second.

In some embodiments, the system may further include a remote network connected server for receiving data from the deep-learning object detection module, whereby the machine learning algorithm can be further trained. Alternatively, or in addition, the system may comprise a local backup for receiving data from the deep-learning object detection module.

In some embodiments, the detected physical gesture may include a ‘thumb up’ hand gesture which is categorised as a positive customer feedback, and a ‘thumb down’ hand gesture which is categorised as a negative customer feedback.

In accordance to another aspect of the disclosure, there is provided a method of assessing customer satisfaction from a physical gesture of a customer using a system having a video camera for capturing video frames of the customer making the physical gesture; and a deep learning object-detection module for detecting the physical gesture by analysing the captured video frames, and for categorising the physical gesture as a specific customer feedback result, the method comprising:

a) capturing video frames of the customer making the physical gesture;

b) detecting the physical gesture by analysing the captured video frames; and

c) categorising the physical gesture as a specific customer feedback.

In some embodiments, the system may further comprise a display screen, and the method may further comprise displaying a visual image to the customer based on the customer feedback on the display screen. The system may also further comprise a sound emitting device, and the method may further comprise emitting a sound to the customer based on the customer feedback result.

In some embodiments, the physical gesture detected by the method may include a ‘thumb up’ hand gesture which is categorised as a positive customer feedback, and a ‘thumb down’ hand gesture which is categorised as a negative customer feedback.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention, wherein

FIG. 1 is a schematic view of a system for assessing customer satisfaction from a physical gesture of a customer according to an embodiment of the present invention; and

FIG. 2 is a block diagram showing the operation of an embodiment of the present invention.

### DETAILED DESCRIPTION

Throughout this document, unless otherwise indicated to the contrary, the terms “comprising”, “consisting of”, “having” and the like, are to be construed as non-exhaustive, or in other words, as meaning “including, but not limited to”.

Furthermore, throughout the specification, unless the context requires otherwise, the word “include” or variations such as “includes” or “including” will be understood to imply the inclusion of a stated integer or group of integers but not the exclusion of any other integer or group of integers.

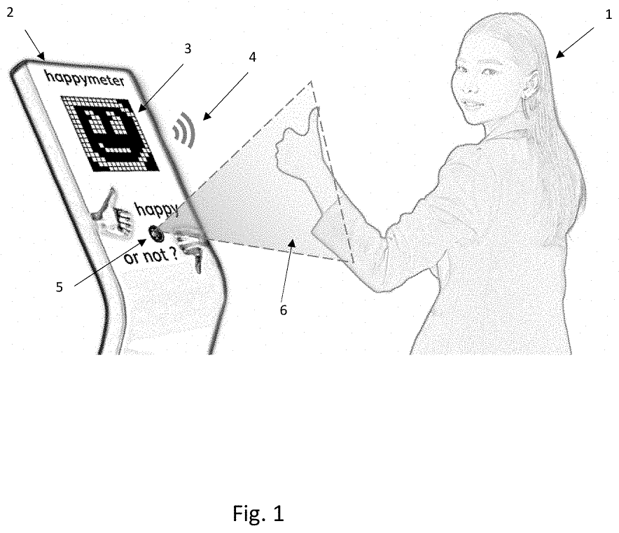

Referring initially to FIG. 1, there is shown an embodiment of a system for assessing customer satisfaction from a physical gesture of a customer according to the present disclosure. The system can be provided within a self-standing kiosk 2, upon which is mounted a video camera 5, having a wide angle of view 6, to capture video frames of a customer 1, standing in front of the kiosk 2. The customer is shown making a “thumbs up” hand gesture, which represents a positive customer feedback for the system according to the present disclosure. A negative customer feedback can however be a “thumbs down” hand gesture by the customer. It is also envisaged that other hand or even face gestures by the customer could be detected by the system to represent different customer satisfaction responses. While the kiosk 2 in FIG. 1 is freestanding, it is also envisaged that the system be supported on a smaller device that can be placed, for example, on the counter of a shop or restaurant.

The kiosk 2 further supports an LED matrix panel 3, as well as, optionally, a speaker 4 to enable the system to respond to the customer feedback. The response can be a “happy face” or an animation displayed on the screen, and a positive sound from the speaker 4 when the customer provides a positive customer feedback with the “thumbs up” hand gesture as shown in FIG. 1. By comparison, “a sad face” can be displayed on the screen, and a sad sound emitted from the speaker 4 when the customer provides a negative customer feedback, namely a “thumbs down” hand gesture. It is also envisaged that the LED matrix panel 3 be replaced with another screen such as an LCD screen.

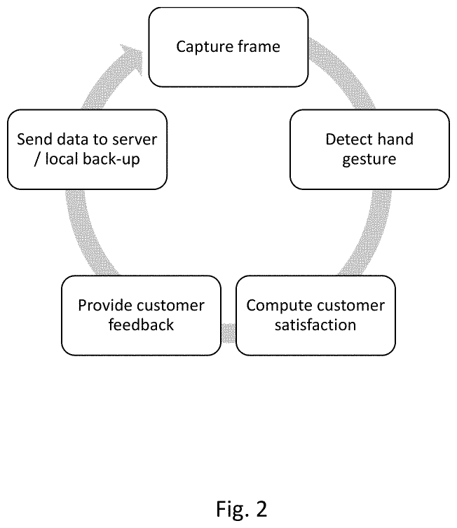

FIG. 2 shows how the system according to the present disclosure operates. There are challenges in running machines learning how algorithms in the cloud, namely the cost of sending a video transmission from a local site to the cloud, and the lack of responsiveness from the cloud. By comparison, the system according to the present disclosure can at least substantially run the algorithm in dedicated hardware on site within the kiosk 2 thereby improving responsiveness. The video camera 5 captures a series of video frames of the customer 1 when making the hand gestures. The captured video frames are then processed within a deep learning object-detection module (not shown) provided on site within the kiosk 2. The object-detection module can include a computer, for example, a small single board Linux-based computer with networking capabilities, together with a deep-learning accelerator device for supporting the processing of a high video frame rate of at least 5 frames per second. This allows the object-detection module to process a real time video feed from the camera 5 on site within the kiosk 2. It is also envisaged that the computer and deep-learning accelerator device be replaced by a single computing device having the requisite computing power to process the real time video feed. The object-detection module can also be connected through a network (wired or wireless) to a remote server, the purpose of which would be subsequently described. The object-detection module runs a machine learning algorithm based on a deep-learning object-detection model with a feature extractor. The deep-learning object-detection module may be a “Single Shot Multibox Detector (SSD)” algorithm, while the feature extractor can be “Mobilenet”, which is an algorithm suitable for mobile and embedded based vision applications. The use of other deep learning object detection models is also envisaged, for example, Faster-R-CNN, R-FCN, FPN, RetinaNet and YOLO. Furthermore, other feature extractors such as VGG16, ResNet and Inception could also be used.

For each frame, the algorithm computes, for each of two object classes (namely “thumbs up” and “thumbs down”), how many objects are detected with which confidence level. Above a certain value, it adds the confidence level to obtain a score (positive “thumbs up” and negative “thumbs down”). The total score, to which a time penalty is added, is the sum of the latter score over several frames (assuming at least five frames per second).When the total score reaches a certain threshold, the algorithm assumes that the customer had expressed satisfaction (or dissatisfaction in the case of a negative total score). In that case, a picture or short animation is displayed on the display screen 3, and a sound is played through the speaker 4. In addition, the total score within the time stamp is sent to the backend server. Eventually, the total score is reset to zero and the display goes back to a neutral feedback.

More specifically, the object-detection module according to the present disclosure seeks to classify detected objects into the two classes as noted above. In each video frame, the object-detection module looks for an area in the frame that may contain an object using, for example, the SSD object-detection model. For each area, if an object is detected, that object will be classified to one of the above noted two classes using, for example, the Mobilenet feature extractor. False readings can be filtered out using a mathematical formula to filter false positive (ie. where a gesture is wrongly detected over one of a number of frames), and false negative (ie. where the customer may be presenting a gesture but is not detected over one of a number of frames) readings. A simplified form of this mathematical formula is as follows:

dx=(a−x)*FPS/T0*df

a: frame score (or intermediary score), can be positive (thumb up detection) or negative (thumb down detection)

x: final score, can be positive or negative

dx: incremental score

FPS: Frame Per Second

T0: Time constant

df: incremental frame (=1 because we are computing each frame)

The object-detection module will acknowledge a positive or negative customer satisfaction only if a gesture is detected over several frames. Similarly, the object-detection module will go back to its original state only if there is no detection of a gesture over several frames. The object-detection module uses the following algorithm to acknowledge a positive or negative customer satisfaction as follows:

If (x>t_happy) then happy

Else If (x<t_sad) then sad

Else neutral

t_happy: threshold for happy detection

t_sad: threshold for sad detection

The data that has been collected by the object-detection module can be sent through the network to the remote server and or alternatively through a local backup. The backend server collects detection sent by the kiosks and stores them in a database. A secure web-based application provides access to the data, with the ability to see download and connect to other servers. Depending on the bandwidth and the legislation where the system operates, the object-detection module may optionally send pictures back to the remote server to enhance future training of the machine learning algorithm and to troubleshoot abnormalities (such as when a sales attendant voluntarily tries to boost positive feedback by showing his own thumbs up hand gesture). Some countries have legislation that prevent transmitting and storing people's pictures without their explicit consent. In these situations, the object-detection module can process each picture without saving them nor transmitting them to a remote server. This is an additional advantage of the system according to the present disclosure.

The machine-learning algorithm can be initially trained offsite within the server by providing a batch of pictures of people showing hand gestures that can be collected from sources such as internet image researches, image data banks and personal adhoc pictures. The data from the kiosks of ongoing batches of pictures further trains the algorithm thereby reduce false positive or negative detections by the algorithm. This further training can then improve the inferencing done on site by the object detection module.

It should be appreciated by the person skilled in the art that the above invention is not limited to the embodiments described. In particular, modifications and improvements may be made without departing from the scope of the present invention.

It should be further appreciated by the person skilled in the art that one or more of the above modifications or improvements, not being mutually exclusive, may be further combined to form yet further embodiments of the present invention.

1. A system for assessing customer satisfaction from a hand gesture of a customer, comprising:
a video camera for capturing video frames of the customer making the hand gesture; and
a deep-learning object-detection module for detecting the hand gesture by analysing an object detected over several of the captured video frames to thereby obtain a confidence score, and for categorising the hand gesture as a specific customer feedback result based on the score.

2. The system according to claim 1, further comprising a display screen for displaying a visual image to the customer based on the customer feedback result.

3. The system according to claim 1, further comprising a sound emitting device for emitting a sound to the customer based on the customer feedback result.

4. The system according to claim 1, wherein the deep learning object detection module includes a processor located on site for running a machine learning algorithm based on a deep learning object detection model with a feature extractor.

5. The system according to claim 4, wherein the deep learning object detection model is a Single Shot MultiBox Detector (SSD) algorithm.

6. The system according to claim 4, wherein the feature extractor is a Mobilenet algorithm.

7. The system according to claim 1, wherein the deep learning module further includes a deep learning accelerator device for supporting the processing of a high video frame rate.

8. The system according to claim 7, wherein the video frame rate is greater than or equal to 5 frames per second.

9. The system according to claim 1, further comprising a remote network connected server for receiving data from the deep-learning object detection module, whereby the machine learning algorithm can be further trained.

10. The system according to claim 1, further comprising a local backup for receiving data from the deep-learning object detection module.

11. The system according to claim 1, wherein the detected hand gesture includes a ‘thumb up’ hand gesture which is categorised as a positive customer feedback, and a ‘thumb down’ hand gesture which is categorised as a negative customer feedback.

12. A method of assessing customer satisfaction from a hand gesture of a customer using a system having a video camera for capturing video frames of the customer making the hand gesture; and a deep learning object-detection module for detecting the hand gesture by analysing the captured video frames, and for categorising the hand gesture as a specific customer feedback result, the method comprising:
a) capturing video frames of the customer making the hand gesture;
b) detecting the hand gesture by analysing an object detected over several of the captured video frames to thereby obtain a confidence score; and
c) categorising the hand gesture as a specific customer feedback.

13. The method according to claim 12, the system further comprising a display screen, wherein the method further comprises displaying a visual image to the customer based on the customer feedback on the display screen.

14. The method according to claim 12, the system further comprising a sound emitting device, wherein the method further comprises emitting a sound to the customer based on the customer feedback result.

15. The method according to claim 12, wherein the detected hand gesture includes a ‘thumb up’ hand gesture which is categorised as a positive customer feedback, and a ‘thumb down’ hand gesture which is categorised as a negative customer feedback.
